(19) United States
(12) Patent Application Publication
(10) Pub. No.: US 2024/0097576 A1
(43) Pub. Date: Mar. 21, 2024

(54) DC POWER SUPPLY DEVICE, MOTOR DRIVING DEVICE, AND REFRIGERATION CYCLE APPLICATION APPARATUS

(71) Applicant: Mitsubishi Electric Corporation, Tokyo (JP)

(72) Inventors: Yuichi SHIMIZU, Tokyo (JP); Kazunori HATAKEYAMA, Tokyo (JP)

(21) Appl. No.: 18/256,799

(22) PCT Filed: Feb. 17, 2021
(86) PCT No.: PCT/JP2021/005939

§ 371 Date: Jun. 9, 2023

(51) Int. Cl. H02M 5/458; H02M 7/06; H02M 7/48

(52) U.S. Cl. CPC H02M 5/458; H02M 7/06; H02M 7/48

(57) ABSTRACT

A DC power supply device includes a rectification circuit, a reactor, a first capacitor and a second capacitor, a first switching element to set the first capacitor in a charging state when the first switching element is in an off state and to set the first capacitor in a non-charging state when the first switching element is in an on state, a second switching element to set the second capacitor in the charging state when the second switching element is in the off state and to set the second capacitor in the non-charging state when the second switching element is in the on state, and a controller. The controller has a full-wave rectification mode as an operation mode in which one of the first and second switching elements is maintained in the off state and the other one of the first and second switching elements undergoes PWM control.

### CROSS REFERENCE TO RELATED APPLICATION

This application is a U.S. national stage application of PCT/JP2021/005939 filed on Feb. 17, 2021, the contents of which are incorporated herein by reference.

### TECHNICAL FIELD

The present disclosure relates to a DC power supply device, a motor driving device and a refrigeration cycle application apparatus.

### BACKGROUND

There has been proposed a DC power supply device including a rectification circuit that rectifies an alternating current, a reactor connected to the rectification circuit, two capacitors connected in series between output terminals, a charging circuit that switches between charging and non-charging of each capacitor, and a controller that controls the charging circuit (see Patent Reference 1, for example). The controller implements a step-up mode for boosting output voltage between the output terminals by controlling the charging circuit so as to maintain a state in which the two capacitors connected in series are charged alternately, and implements a full-wave rectification mode by controlling the charging circuit so as to maintain a state in which the two capacitors connected in series are charged simultaneously.

### PATENT REFERENCE

Patent Reference 1: WO 2015/033437

However, the sum total of the capacitances of the two capacitors connected in series is lower than the capacitance of one capacitor. For example, when the capacitances of the two capacitors are equal to each other, the sum total of the capacitances of the two capacitors connected in series is ½ of the capacitance of one capacitor. Thus, in the conventional DC power supply device described above, there is a danger of a rise in ripples in the output voltage between the output terminals in a period of the full-wave rectification mode. The rise in the ripples causes a rise in power line harmonics and a decrease in the power factor and can deteriorate the efficiency of the DC power supply device.

### SUMMARY

An object of the present disclosure, which has been made to resolve the above-described problems, is to provide a DC power supply device capable of inhibiting the rise in the ripples in the output voltage, a motor driving device including the DC power supply device, and a refrigeration cycle application apparatus including the motor driving device.

A DC power supply device in the present disclosure includes a rectification circuit to rectify an alternating current; a reactor connected to the rectification circuit; a first capacitor and a second capacitor connected in series between output terminals for a direct current generated by the rectification circuit and the reactor; a first switching element to set the first capacitor in a charging state when the first switching element is in an off state and to set the first capacitor in a non-charging state when the first switching element is in an on state; a second switching element to set the second capacitor in the charging state when the second switching element is in the off state and to set the second capacitor in the non-charging state when the second switching element is in the on state; and a controller to control switching operation of each of the first and second switching elements, wherein the controller has a full-wave rectification mode as an operation mode in which one of the first and second switching elements is maintained in the off state and the other one of the first and second switching elements undergoes PWM control. When voltage of the direct current is in a stationary state, the controller executes control of alternately switching between: a first full-wave rectification mode in which the second switching element is maintained in the off state and an on duty ratio of the first switching element is set at a value greater than 0% and less than or equal to 100%; and a second full-wave rectification mode in which the first switching element is maintained in the off state and the on duty ratio of the second switching element when the voltage of the direct current has reached the stationary state is set at a value greater than 0% and less than or equal to 100%.

According to the present disclosure, the rise in the ripples in the output voltage can be inhibited.

### BRIEF DESCRIPTION OF THE DRAWINGS

FIG. 1 is a diagram showing a configuration example of a DC power supply device according to a first embodiment.

FIG. 2 is a diagram showing a relationship between each state of first and second switching elements of a charging circuit of the DC power supply device shown in FIG. 1 and current paths.

FIG. 3 is a diagram showing examples of an operation mode of the DC power supply device shown in FIG. 1.

FIG. 4 shows an example of waveforms of input current to a rectification circuit, output voltage detected by a third detection unit, and voltages detected by first and second detection units when the DC power supply device shown in FIG. 1 is made to operate in a full-wave rectification mode (comparative example) in FIG. 3.

FIG. 5 shows another example of the waveforms of the input current to the rectification circuit, the output voltage detected by the third detection unit, and the voltages detected by the first and second detection units when the DC power supply device shown in FIG. 1 is made to operate in the full-wave rectification mode (comparative example) in FIG. 3.

FIG. 6(a) is a diagram showing an example of the operation mode of the DC power supply device according to the first embodiment, and FIG. 6(b) is a diagram showing an example of the operation mode of a DC power supply device according to a second embodiment.

FIG. 7 shows an example of waveforms of the input current to the rectification circuit, the output voltage detected by the third detection unit, the voltages detected by the first and second detection units, a load, and an on duty ratio of a first switching element when the DC power supply device according to the first embodiment is made to operate in the full-wave rectification mode.

FIG. 8 shows the waveforms of the input current, the output voltage detected by the third detection unit, and the voltages detected by the first and second detection units shown in FIG. 7.

FIG. 9 shows an example of waveforms of the input current to the rectification circuit, the output voltage detected by the third detection unit, the voltages detected by the first and second detection units, the load, and the on duty ratio of the first switching element when a DC power supply device according to a second embodiment is made to operate in the full-wave rectification mode.

FIG. 10 is a diagram showing an example of the operation mode of a DC power supply device according to a third embodiment.

FIG. 11 shows an example of waveforms of the input current to the rectification circuit, the output voltage detected by the third detection unit, the voltages detected by the first and second detection units, the load, and the on duty ratio of the second switching element when the DC power supply device according to the third embodiment is made to operate in the full-wave rectification mode.

FIG. 12 is a diagram showing a configuration example of a DC power supply device according to a fifth embodiment.

FIG. 13 is a diagram showing a configuration example of a DC power supply device, a motor driving device and a refrigeration cycle application apparatus according to a sixth embodiment.

FIG. 14 is a flowchart showing an operation example of switching of an energization pattern of the DC power supply device according to the sixth embodiment.

FIG. 15 shows an example of waveforms of the input current to the rectification circuit, the output voltage detected by the third detection unit, the voltages detected by the first and second detection units, the load, and the on duty ratio of the first switching element at the time of switching the energization pattern of the DC power supply device according to the sixth embodiment.

FIG. 16 shows another example of the waveforms of the input current to the rectification circuit, the output voltage detected by the third detection unit, the voltages detected by the first and second detection units, the load, and the on duty ratio of the first switching element at the time of switching the energization pattern of the DC power supply device according to the sixth embodiment.

FIG. 17 shows another example of the waveforms of the input current to the rectification circuit, the output voltage detected by the third detection unit, the voltages detected by the first and second detection units, the load, and the on duty ratio of the first switching element at the time of switching the energization pattern of the DC power supply device according to the sixth embodiment.

### DETAILED DESCRIPTION

A DC power supply device, a motor driving device including the DC power supply device, and a refrigeration cycle application apparatus including the motor driving device according to each embodiment will be described below with reference to the drawings. The following embodiments are just examples and it is possible to appropriately combine embodiments and appropriately modify each embodiment. Furthermore, the same or similar components are assigned the same reference character in the drawings.

### First Embodiment

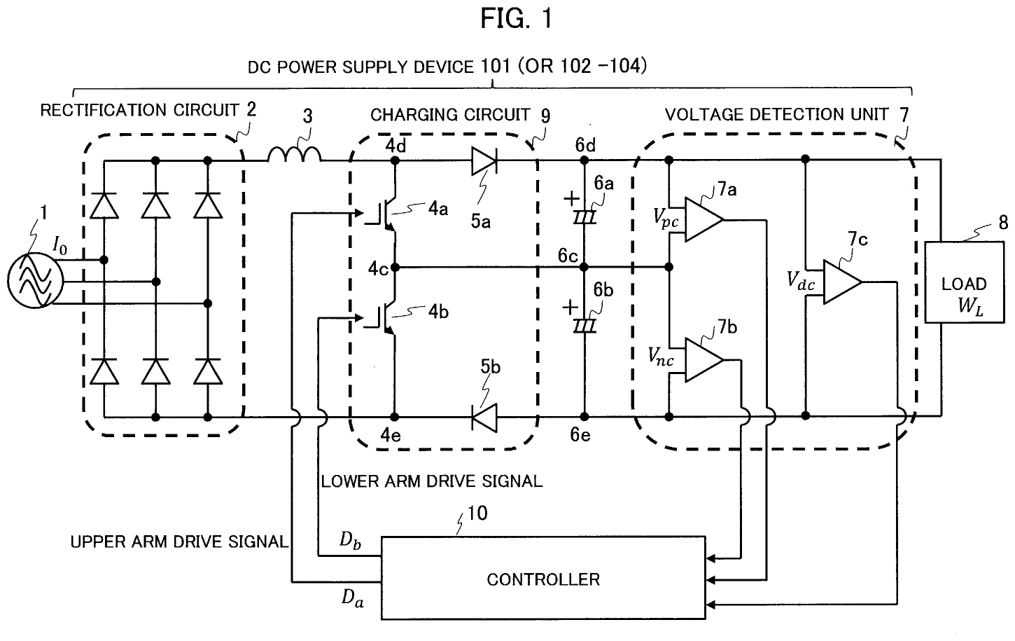

FIG. 1 is a diagram showing a configuration example of a DC power supply device 101 according to a first embodiment. As shown in FIG. 1, the DC power supply device 101 is configured to convert an alternating current supplied from an AC power supply 1 to a direct current and to supply the direct current to a load circuit 8 from output terminals (i.e., connection points 6d and 6e). The load circuit 8 is, for example, an inverter that drives a compressor motor used for a refrigeration cycle device (refrigeration cycle device 301 described in a sixth embodiment which will be described later). The refrigeration cycle device is used for an air conditioner, a heat pump water heater, a refrigerator, a freezing machine, or the like. Furthermore, the load circuit 8 is not limited to an inverter.

The DC power supply device 101 includes a rectification circuit 2 that rectifies the alternating current, (e.g., three-phase AC current in FIG. 1), a reactor 3 connected to the rectification circuit 2, and a first capacitor 6a and a second capacitor 6b connected in series between the output terminals (i.e., the connection points 6d and 6e) for the direct current generated by the rectification circuit 2 and the reactor 3. Further, the DC power supply device 101 includes a first switching element 4a that sets the first capacitor 6a in a charging state when the first switching element 4a is in an off state and sets the first capacitor 6a in a non-charging state when the first switching element 4a is in an on state, a second switching element 4b that sets the second capacitor 6b in the charging state when the second switching element 4b is in the off state and sets the second capacitor 6b in the non-charging state when the second switching element 4b is in the on state, and a controller 10 that controls the switching operation of each of the first and second switching elements 4a and 4b. Further, the DC power supply device 101 includes a voltage detection unit 7 as a voltage detection circuit that detects the output voltage V_{dc} [V] between the output terminals (i.e., the connection points 6d and 6e).

The first and second switching elements 4a and 4b form a charging circuit 9. Further, while the reactor 3 is connected to the output side of the rectification circuit 2 in FIG. 1, it is also possible to connect the reactor 3 to each phase on the input side of the rectification circuit 2. In the first embodiment, the controller 10 has a full-wave rectification mode as an operation mode in which one of the first and second switching elements 4a and 4b is maintained in the off state and the other of the first and second switching elements 4a and 4b undergoes PWM (Pulse Width Modulation) control. Further, the controller 10 has a step-up mode as an operation mode in which each of the first and second switching elements 4a and 4b is PWM controlled.

The voltage detection unit 7 includes a first detection unit 7a that detects voltage V_{pc} [V] of the first capacitor 6a, a second detection unit 7b that detects voltage V_{nc} [V] of the second capacitor 6b, and a third detection unit 7c that detects the output voltage V_{dc} [V] as the voltage between a positive electrode of the first capacitor 6a and a negative electrode of the second capacitor 6b.

Since V_{dc}=V_{pc}+V_{nc} holds, the voltage detection unit 7 may also be configured to include two of the first detection unit 7a, the second detection unit 7b and the third detection unit 7c. In other words, the voltage detection unit 7 is capable of acquiring the voltage V_{pc} [V], the voltage V_{nc} [V] and the output voltage V_{dc} [V] if the voltage detection unit 7 includes two or more detection units out of the first detection unit 7a, the second detection unit 7b and the third detection unit 7c.

Further, the charging circuit 9 includes a first backflow prevention element 5a that prevents electric charge for charging the first capacitor 6a from flowing back to the first switching element 4a and a second backflow prevention element 5b that prevents electric charge for charging the second capacitor 6b from flowing back to the second switching element 4b, in addition to the first switching element 4a that switches the first capacitor 6a to the charging state or the non-charging state and the second switching element 4b that switches the second capacitor 6b to the charging state or the non-charging state.

As shown in FIG. 1, a midpoint 4c of a series circuit formed by the first switching element 4a and the second switching element 4b is connected to a midpoint 6c of a series circuit formed by the first capacitor 6a and the second capacitor 6b. The first backflow prevention element 5a, as a diode whose forward direction is a direction heading from a collector 4d of the first switching element 4a towards the connection point 6d of the first capacitor 6a and the load circuit 8, is connected between the collector 4d of the first switching element 4a and the connection point 6d of the first capacitor 6a and the load circuit 8. The second backflow prevention element 5b, as a diode whose forward direction is a direction heading from the connection point 6e of the second capacitor 6b and the load circuit 8 towards an emitter 4e of the second switching element 4b, is connected between the connection point 6e of the second capacitor 6b and the load circuit 8 and the emitter 4e of the second switching element 4b.

In the example shown in FIG. 1, capacitors having the same capacitance as each other are used as the first capacitor 6a and the second capacitor 6b. As the first switching element 4a and the second switching element 4b, it is possible to use semiconductor switching elements such as power transistors, power MOSFETs (power Metal-Oxide-Semiconductor Field-Effect Transistors) or IGBTs (Insulated Gate Bipolar Transistors), for example. To the semiconductor switching elements forming the first switching element 4a and the second switching element 4b, a freewheeling diode (not shown) may be connected in parallel with the semiconductor switching elements for the purpose of inhibiting surge voltage caused by the switching. The freewheeling diode can also be a parasitic diode of the semiconductor switching elements. In the case where the semiconductor switching elements are MOSFETs, a function similar to the freewheeling diode can be implemented by turning the semiconductor switching elements to the on state with the timing of freewheeling.

The material forming the semiconductor switching elements is silicon (Si), for example. However, the material forming the semiconductor switching elements is not limited to Si but can also be a constituent material of a wide band gap semiconductor. The constituent material of the wide band gap semiconductor is silicon carbide (SiC), gallium nitride (GaN), gallium oxide (Ga₂O₃) or diamond, for example. When the semiconductor switching elements are formed with a wide band gap semiconductor, a decrease in the loss and an increase in the switching speed can be realized.

The controller 10 controls the output voltage V_{dc} [V] as DC voltage supplied to the load circuit 8 by performing on-off control on the first switching element 4a and the second switching element 4b. The controller 10 can be formed with an electric circuit such as an analog circuit or a digital circuit. Further, this electric circuit may be formed with a discrete system including a CPU (Central Processing Unit), a DSP (Digital Signal Processor) or a microcomputer (micom) as a processor that executes a program as software stored in a memory. The switching control of the first switching element 4a and the second switching element 4b executed by the controller 10 will be described below.

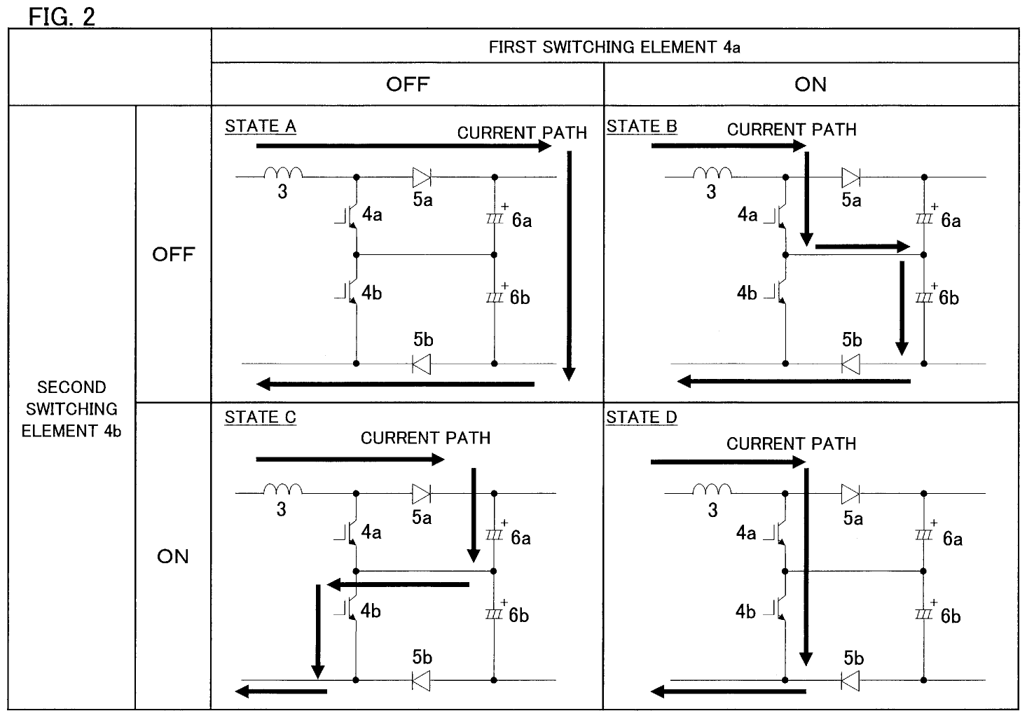

FIG. 2 is a diagram showing a relationship between each state of the first switching element 4a and the second switching element 4b of the charging circuit 9 of the DC power supply device 101 shown in FIG. 1 and an electric current path (i.e., the switching control).

A state A in FIG. 2 indicates the electric current path when both of the first switching element 4a and the second switching element 4b are undergoing off control. In the state A, the charging of both of the first capacitor 6a and the second capacitor 6b is executed. Namely, in the state A, both of the first capacitor 6a and the second capacitor 6b are in the charging state.

A state B in FIG. 2 indicates the electric current path when the first switching element 4a is undergoing on control and the second switching element 4b is undergoing the off control. In the state B, the charging of the second capacitor 6b is executed whereas the charging of the first capacitor 6a is not executed. Namely, in the state B, the first capacitor 6a is in the non-charging state and the second capacitor 6b is in the charging state.

A state C in FIG. 2 indicates the electric current path when the first switching element 4a is undergoing the off control and the second switching element 4b is undergoing the on control. In the state C, the charging of the first capacitor 6a is executed whereas the charging of the second capacitor 6b is not executed. Namely, in the state C, the first capacitor 6a is in the charging state and the second capacitor 6b is in the non-charging state.

A state D in FIG. 2 indicates the electric current path when both of the first switching element 4a and the second switching element 4b are undergoing the on control (i.e., in a short circuit condition). In the state D, the charging of the first capacitor 6a is not executed and the charging of the second capacitor 6b is not executed either. Namely, in the state D, both of the first capacitor 6a and the second capacitor 6b are in the non-charging state.

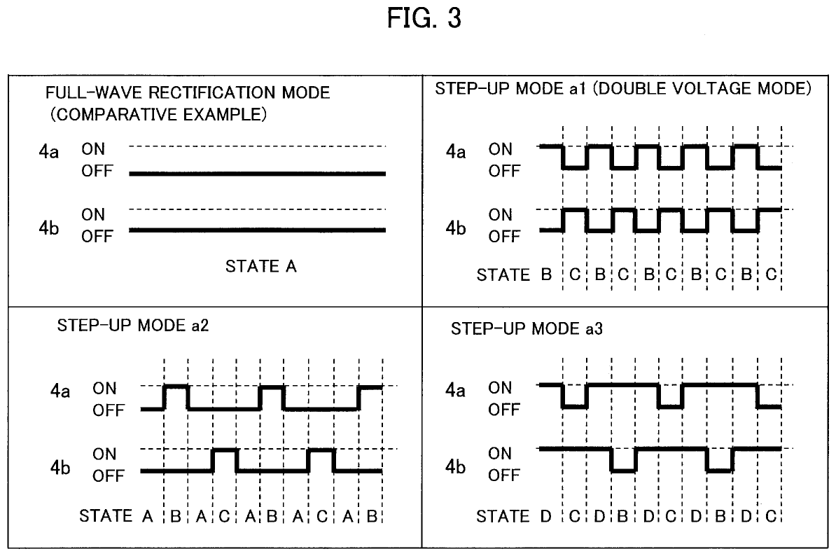

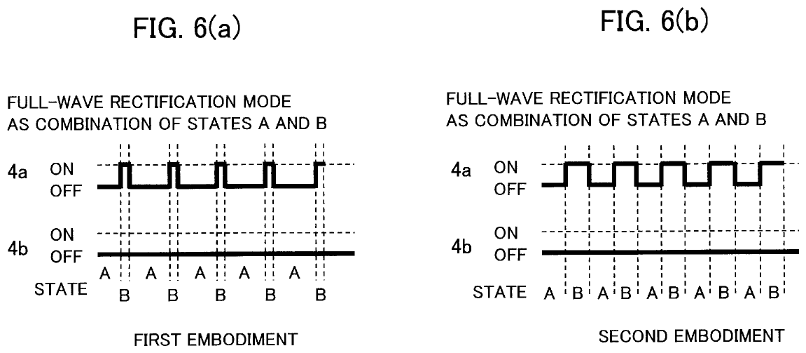

FIG. 3 is a diagram showing examples of the operation mode of the DC power supply device 101 shown in FIG. 1. In FIG. 3, the full-wave rectification mode (comparative example) is the conventional full-wave rectification mode in which both of the first switching element 4a and the second switching element 4b are constantly off controlled. The DC power supply device 101 according to the first embodiment executes a full-wave rectification mode shown in FIG. 6(a) which will be explained later instead of the full-wave rectification mode (comparative example) shown in FIG. 3. Further, the DC power supply device 101 according to the first embodiment executes the step-up mode in which the on-off control is performed on each of the first switching element 4a and the second switching element 4b with different timing. FIG. 3 shows a step-up mode a1, a step-up mode a2 and a step-up mode a3 as examples of the step-up mode.

As the step-up mode, there are the step-up mode a1 (double voltage mode) in which a on duty ratio Dₐ of the first switching element 4a is 50% and a on duty ratio D_{b} of the second switching element 4b is 50%, the step-up mode a2 in which each of the on duty ratios Dₐ and D_{b} of the first switching element 4a and the second switching element 4b is less than 50%, and the step-up mode a3 in which each of the on duty ratios Dₐ and D_{b} of the first switching element 4a and the second switching element 4b is higher than 50%.

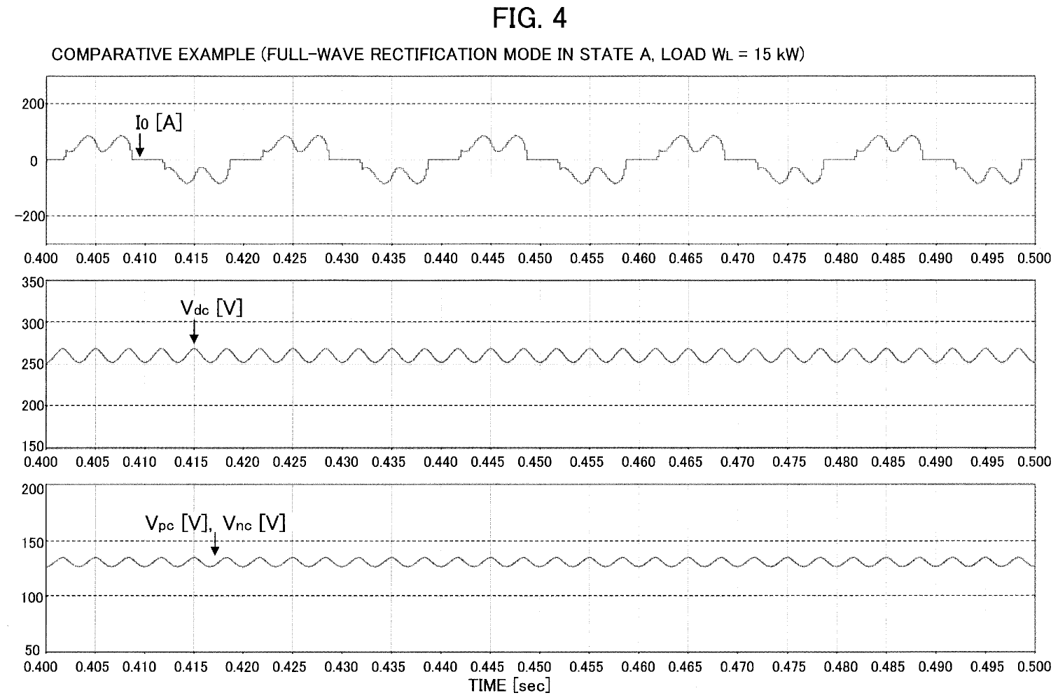

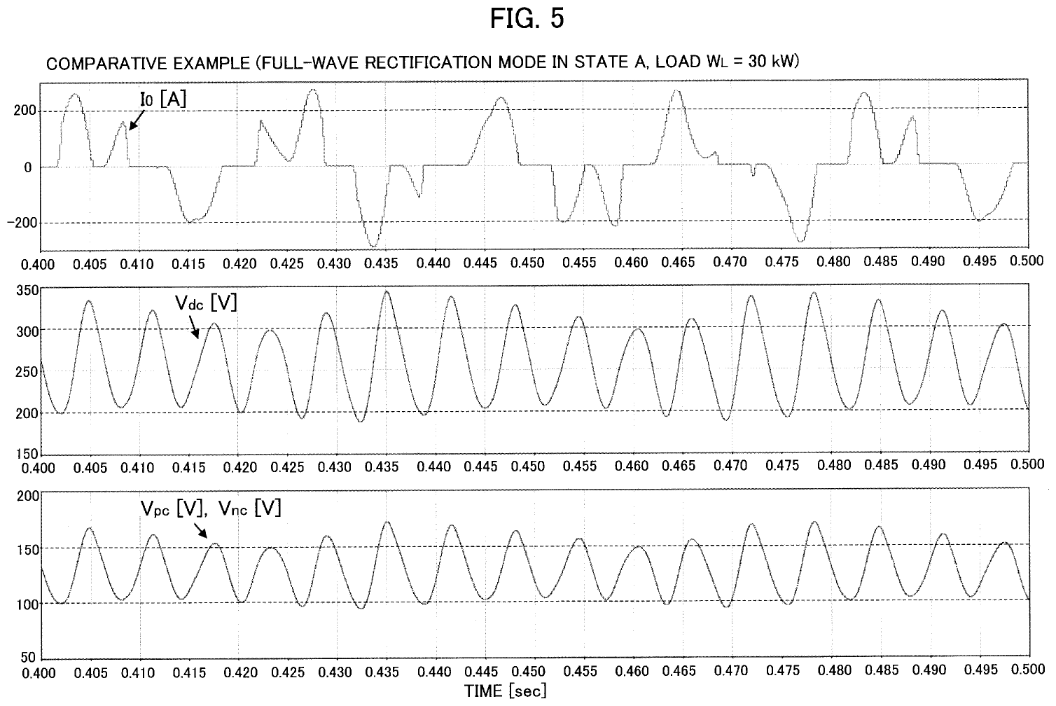

Next, the output voltage in each operation mode shown in FIG. 3 will be explained below. In the full-wave rectification mode (comparative example) shown in FIG. 3, the current path in the state A in FIG. 2 is formed, and voltage generated by the full-wave rectification executed by the rectification circuit 2 serves as the output voltage. In this case, the output voltage is shown as output voltage V_{dc} [V] in FIG. 4 and FIG. 5 which will be explained later, for example.

In the step-up mode a1 (double voltage mode), on-timing of the first switching element 4a and off-timing of the second switching element 4b are substantially at the same time, the off-timing of the first switching element 4a and the on-timing of the second switching element 4b are substantially at the same time, and the current path in the state B in FIG. 2 and the current path in the state C in FIG. 2 are formed alternately. The output voltage in this case is approximately twice the output voltage in the full-wave rectification mode.

In the step-up mode a2, there is provided a simultaneous off period in which the first switching element 4a and the second switching element 4b are both off. Namely, the on duty ratios Dₐ and D_{b} of the first switching element 4a and the second switching element 4b are lower than 50%. In this case, state transitions in the order of the state B, the state A, the state C and the state A in FIG. 2 are repeated periodically. The output voltage in this case is in a range between the output voltage in the full-wave rectification mode and the output voltage in the step-up mode a1 (double voltage mode), and the output voltage approaches the output voltage in the step-up mode a1 (double voltage mode) as the on duty ratios Dₐ and D_{b} of the first switching element 4a and the second switching element 4b approach 50%.

In the step-up mode a3, there is provided a simultaneous on period in which the first switching element 4a and the second switching element 4b are both on. Namely, the on duty ratios Dₐ and D_{b} of the first switching element 4a and the second switching element 4b are higher than 50%. In this case, state transitions in the order of the state D, the state C, the state D and the state B in FIG. 2 are repeated periodically. Energy is accumulated in the reactor 3 in the simultaneous on period of the first switching element 4a and the second switching element 4b (in this example, the period of the state D). The output voltage in the step-up mode a3 is voltage higher than or equal to the output voltage in the step-up mode a1 (double voltage mode).

The controller 10 is capable of controlling the DC output voltage V_{dc} [V] supplied to the load circuit 8 by changing the on duty ratios Dₐ and D_{b} of the first switching element 4a and the second switching element 4b.

The problems to be solved by the DC power supply device 101 according to the first embodiment will be described below. Assuming that the capacitance of the first capacitor 6a is Cₚ, the capacitance of the second capacitor 6b is Cₙ, and composite capacitance when the first capacitor 6a and the second capacitor 6b are connected in series is Cₚₙ, in the state A in FIG. 2, the charging current flows into both of the first capacitor 6a and the second capacitor 6b when the first capacitor 6a and the second capacitor 6b are in the series connection state, and thus Cₚₙ<Cₚ and Cₚₙ<Cₙ hold. Further, when the capacitance Cₚ and the capacitance Cₙ are the same, the composite capacitance Cₚₙ is ½ of the capacitance Cₚ or Cₙ. Especially in the full-wave rectification mode (comparative example) shown in FIG. 3, the state A continues, and thus the charging/discharging is performed on the composite capacitance Cₚₙ.

FIG. 4 shows an example of waveforms of input current I₀ [A] to the rectification circuit 2, the output voltage V_{dc} [V] detected by the third detection unit 7c, the voltage V_{pc} [V] detected by the first detection unit 7a, and the voltage V_{nc} [V] detected by the second detection unit 7b when the DC power supply device 101 is made to operate in the full-wave rectification mode (comparative example) in FIG. 3. FIG. 4 shows an example of the waveforms when the load W_{L} [kW] consumed by the load circuit 8 is 15 kW.

FIG. 5 shows another example of the waveforms of the input current I₀ [A] to the rectification circuit 2, the output voltage V_{dc} [V] detected by the third detection unit 7c, the voltage V_{pc} [V] detected by the first detection unit 7a, and the voltage V_{nc} [V] detected by the second detection unit 7b when the DC power supply device 101 is made to operate in the full-wave rectification mode (comparative example) in FIG. 3. FIG. 5 shows an example of the waveforms when the load W_{L} [kW] consumed by the load circuit 8 is 30 kW.

As shown in FIG. 4, when the load W_{L} [kW] as electric power consumed by the load circuit 8 is low in the full-wave rectification mode (comparative example), the ripples in the output voltage V_{dc} [V] are small. However, as shown in FIG. 5, the ripples in the output voltage V_{dc} [V] are large when the load W_{L} [kW] as the electric power consumed by the load circuit 8 is high in the full-wave rectification mode (comparative example). The rise in the ripples in the output voltage V_{dc} [V] can accelerate the shortening of the operating life of the first and second capacitors 6a and 6b, causes a rise in power line harmonics or a decrease in the power factor, and deteriorates the efficiency of the DC power supply device 101. Further, if capacitors with high capacitance are used as the first and second capacitors 6a and 6b to solve such problems, that leads to a cost rise of the DC power supply device. Therefore, in the DC power supply device 101 according to the first embodiment, an operation mode of setting the second switching element 4b in the off state and performing the PWM control on the first switching element 4a is executed as the full-wave rectification mode.

FIG. 6(a) is a diagram showing an example of the operation mode of the DC power supply device 101 according to the first embodiment. FIG. 6(b) is a diagram showing an example of the operation mode of a DC power supply device 102 according to a second embodiment which will be described later. In the DC power supply device 101 according to the first embodiment, energization according to an energization pattern shown in FIG. 6(a) as a combination of the state A and the state B in FIG. 2 is executed in the full-wave rectification mode.

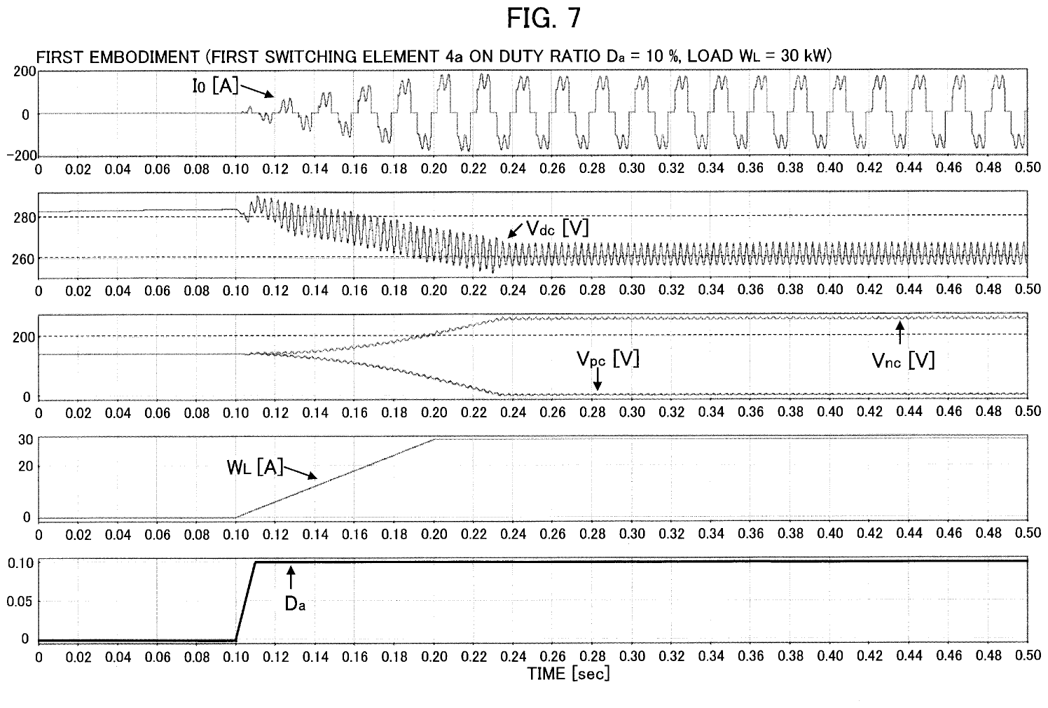

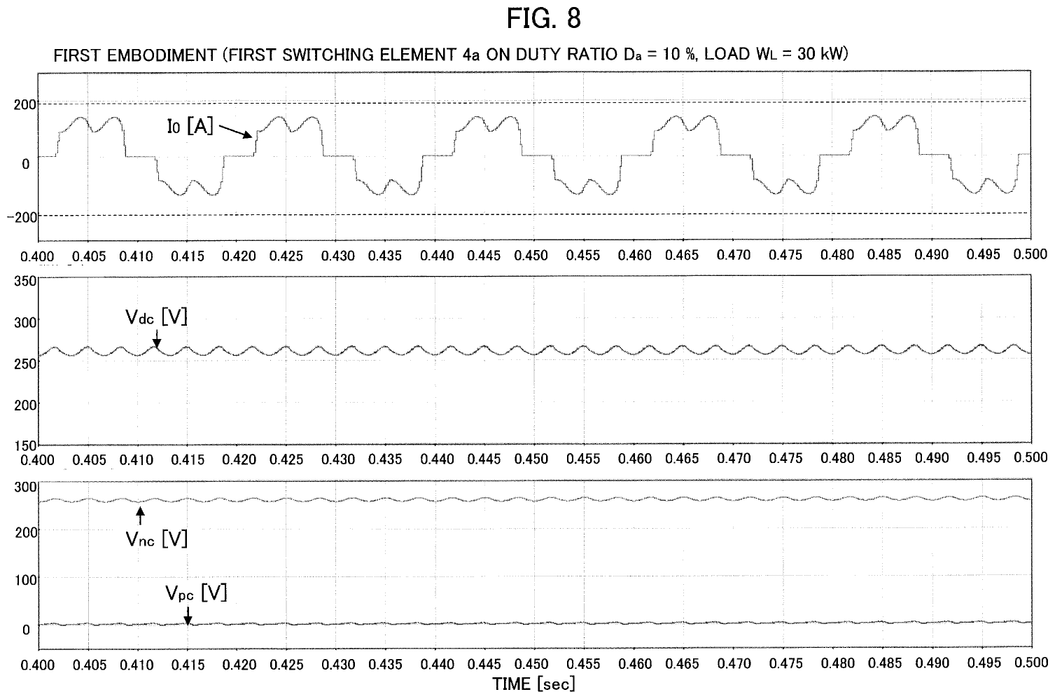

FIG. 7 shows an example of the waveforms of the input current I₀ [A] to the rectification circuit 2, the output voltage V_{dc} [V] detected by the third detection unit 7c, the voltage V_{pc} [V] detected by the first detection unit 7a, and the voltage V_{dc} [V] detected by the second detection unit 7b when the DC power supply device 101 according to the first embodiment is made to operate in the full-wave rectification mode. FIG. 7 shows an example of the waveforms when the load W_{L} [kW] consumed by the load circuit 8 is 15 kW. FIG. 7 shows operation waveforms when magnitude of the load W_{L} [kW] on the load circuit 8 and the on duty ratio Dₐ of the first switching element 4a are increased linearly in the configuration shown in FIG. 1. FIG. 8 shows the waveforms of the input current I₀ [A], the output voltage V_{dc} [V] as the voltage detected by the third detection unit 7c, the voltage V_{pc} [V] detected by the first detection unit 7a, and the voltage V_{dc} [V] detected by the second detection unit 7b shown in FIG. 7 while magnifying the time axis. The on duty ratio Dₐ of the first switching element 4a may also be increased stepwise. However, it is desirable to increase the on duty ratio Dₐ linearly or like an S-shaped curve in order to prevent an excessively high peak of the charging current to the first capacitor 6a (i.e., in order to hold down the peak).

The load W_{L} [kW] on the load circuit 8 increases from 0 kW to 30 kW in a period from a time point of 0.10 seconds to a time point of 0.20 seconds, and the on duty ratio Dₐ of the first switching element 4a is increased from 0% to 10% (=0.10) in a period from the time point of 0.10 seconds to a time point of approximately 0.11 seconds. Due to the increase in the on duty ratio Dₐ of the first switching element 4a to 10%, the second capacitor 6b is charged and the voltage V_{dc} [V] of the second capacitor 6b increases gradually.

Further, since the second switching element 4b is in the off state, with the increase in the load W_{L} [kW] on the load circuit 8, the first capacitor 6a is discharged and the voltage V_{pc} [V] of the first capacitor 6a decreases gradually.

In a stationary state (a state after a time point of approximately 0.26 seconds in FIG. 7) after convergence of the discharging of the first capacitor 6a and the charging of the second capacitor 6b, the voltage V_{pc} [V] of the first capacitor 6a reaches approximately 0 V and the voltage V_{dc} [V] of the second capacitor 6b becomes substantially equal to the voltage generated by the full-wave rectification by the rectification circuit 2. While the energization pattern shown in FIG. 6(a) as the combination of the state A and the state B is used in the first embodiment, also in the state A, the voltage V_{nc} [V] of the second capacitor 6b and the voltage generated by the full-wave rectification by the rectification circuit 2 become substantially equal to each other, and thus the charging current does not flow into the first capacitor 6a (the first capacitor 6a is in the non-charging state) and only the second capacitor 6b assumes the role of a smoothing capacitor. Therefore, compared to the full-wave rectification mode (comparative example) as an operation mode using only the state A in FIG. 3, the capacitance of the circuit can be increased, and the rise in the ripples in the output voltage V_{dc} [V] can be inhibited even when the load W_{L} [kW] on the load circuit 8 is high (W_{L}=30 kW in FIG. 8) as shown in FIG. 8.

As described above, with the DC power supply device 101 according to the first embodiment, the rise in the ripples in the output voltage V_{dc} [V] can be inhibited without the need of increasing the capacitance of the first capacitor 6a and the second capacitor 6b, and thus it is possible to contribute to reduction in the power line harmonics, increasing the power factor and extending the operating life of the capacitors while inhibiting the cost rise of the DC power supply device 101.

### Second Embodiment

In the first embodiment, the description is given of the example in which the second switching element 4b is set in the off state and the on duty ratio Dₐ of the first switching element 4a is low in the full-wave rectification mode as shown in FIG. 6(a) (example in which Dₐ=10%). In contrast, in the second embodiment, a description will be given of an example in which the second switching element 4b is set in the off state and the on duty ratio Dₐ of the first switching element 4a is high as shown in FIG. 6(b) (example in which Dₐ=50%). FIG. 1 to FIG. 3 are also referred to in the description of the DC power supply device 102 according to the second embodiment.

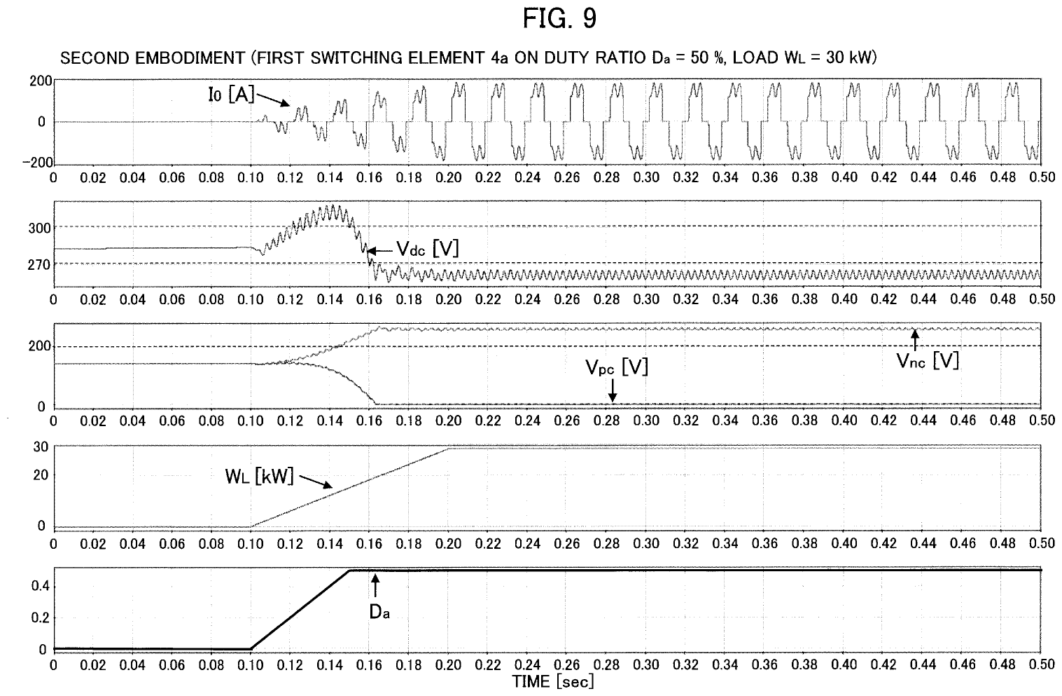

FIG. 9 shows an example of waveforms of the input current I₀ [A] to the rectification circuit 2, the output voltage V_{dc} [V] detected by the third detection unit 7c, the voltage V_{pc} [V] detected by the first detection unit 7a, the voltage V_{nc} [V] detected by the second detection unit 7b, the load W_{L} [kW], and the on duty ratio D a of the first switching element 4a when the DC power supply device 102 according to the second embodiment is made to operate in the full-wave rectification mode. FIG. 9 shows an example of the waveforms when the load W_{L} [kW] consumed by the load circuit 8 is 30 kW. FIG. 9 shows operation waveforms when the load W_{L} [kW] on the load circuit 8 and the on duty ratio Dₐ of the first switching element 4a are increased linearly in the DC power supply device 102 according to the second embodiment shown in FIG. 1. The load W_{L} [kW] increases to reach 30 kW at the time point of 0.2 seconds, and the on duty ratio Dₐ of the first switching element 4a gradually increases from the time point of 0.1 seconds and is increased to 50%. Furthermore, gradients of the increase in the load W_{L} [kW] and the on duty ratio Dₐ in FIG. 9 are the same as those in the first embodiment.

Increasing the on duty ratio Dₐ of the first switching element 4a is synonymous with increasing the ratio of the state B in FIG. 2 and decreasing the ratio of the state A in FIG. 2 as shown in FIG. 6(b). In the DC power supply device 102 according to the second embodiment, the ratio of the state A decreases compared to the case of the first embodiment (i.e., case of FIG. 7), and thus the first capacitor 6a becomes more likely to discharge, and a convergence time as a time necessary to reach the stationary state via a transient state is shorter as is clear from the waveform of the output voltage V_{dc} [V] in FIG. 9.

Further, if the on duty ratio of the first switching element 4a is set at 100%, the whole span of the energization pattern in FIG. 6 is in the state B. In this case, the occurrence of the switching loss can be inhibited since the first switching element 4a is constantly in the on state.

As described above, with the DC power supply device 102 according to the second embodiment, by increasing the on duty ratio Dₐ of the first switching element 4a, the convergence time to reach the stationary state via the transient state can be shortened and it is possible to contribute to efficiency improvement.

Except for the above-described features, the second embodiment is the same as the first embodiment.

### Third Embodiment

In the DC power supply devices 101 and 102 according to the above-described first and second embodiments, in the full-wave rectification mode, the controller 10 constantly sets the second switching element 4b in the off state and performs the PWM control on the first switching element 4a. In the PWM control in the full-wave rectification mode, the on duty ratio Dₐ of the first switching element 4a is set at a value greater than 0% and less than or equal to 100% in the stationary state. In contrast, in a DC power supply device 103 according to a third embodiment, in the full-wave rectification mode, the first switching element 4a is constantly set in the off state and the PWM control is performed on the second switching element 4b. In the PWM control in the full-wave rectification mode, the on duty ratio D_{b} of the second switching element 4b is set at a value greater than 0% and less than or equal to 100% in the stationary state. FIG. 1 to FIG. 3 are also referred to in the description of the DC power supply device 103 according to the third embodiment.

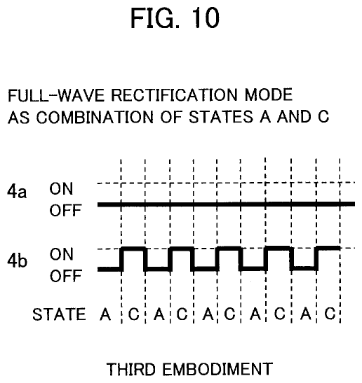

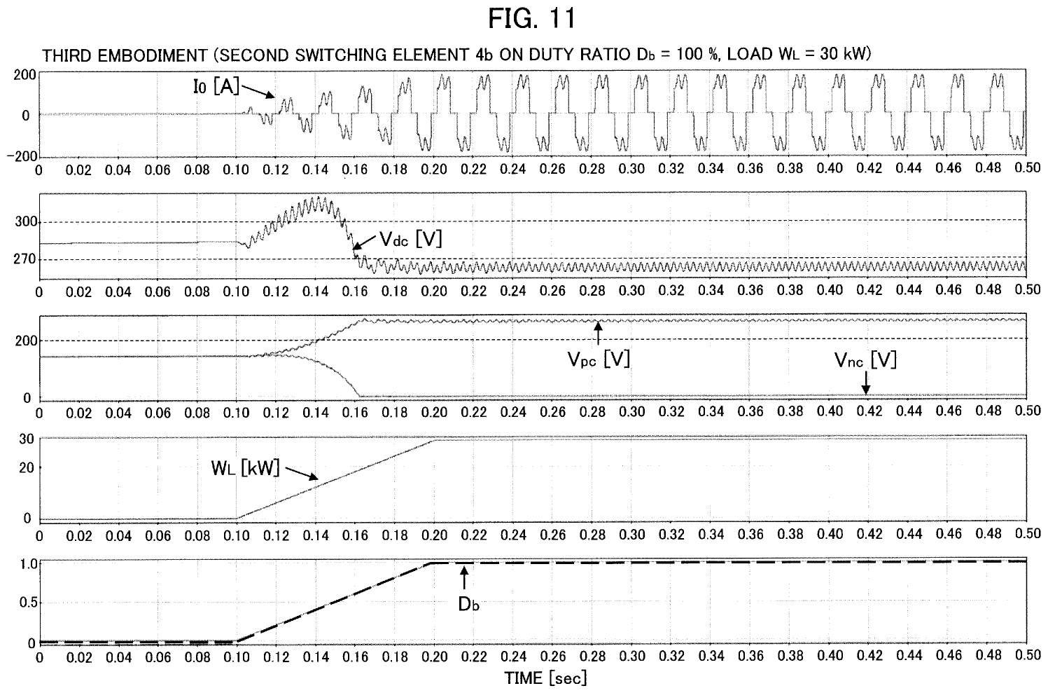

FIG. 10 shows an example of the operation mode of the DC power supply device 103 according to the third embodiment. FIG. 11 shows an example of waveforms of the input current I₀ [A] to the rectification circuit 2, the output voltage V_{dc} [V] detected by the third detection unit 7c, the voltages V_{pc} and V_{dc} [V] detected by the first and second detection units 7a and 7b, the load W_{L} [kW] on the load circuit 8, and the on duty ratio D_{b} of the second switching element 4b when the DC power supply device 103 according to the third embodiment is made to operate in the full-wave rectification mode in FIG. 10. FIG. 11 shows operation waveforms when the load W_{L} [kW] and the on duty ratio D_{b} of the second switching element 4b are increased linearly. The load W_{L} [kW] starts increasing at the time point of 0.1 seconds and increases to 30 kW at a time point of approximately 0.20 seconds. The on duty ratio D_{b} of the second switching element 4b starts increasing at the time point of 0.1 seconds and increases to 100% at a time point of approximately 0.20 seconds. Furthermore, the gradient of the increase in the load W_{L} [kW] is the same as that in the first and second embodiments. The on duty ratio D_{b} of the second switching element 4b may also be increased stepwise. However, it is desirable to increase the on duty ratio D_{b} linearly or like an S-shaped curve in order to prevent an excessively high peak of the charging current to the second capacitor 6b (i.e., in order to hold down the peak).

As is understandable from the waveforms in FIG. 11, also in the case where the first switching element 4a is constantly set in the off state and the second switching element 4b is used for the on-off control, the ripples in the output voltage V_{dc} [V] can be inhibited similarly to the cases in the first and second embodiments.

Further, in cases where the gate of the first switching element 4a as the switching element on the upper side is driven in the use of two switching elements in series connection as in the configuration shown in FIG. 1, it is necessary to prepare a power supply circuit separate from a power supply circuit for driving the gate of the second switching element 4b as the switching element on the lower side or to prepare a bootstrap circuit as the power supply for the first switching element 4a.

In cases where the first switching element 4a is used for the on-off control as described in the first and second embodiments, the second switching element 4b is constantly in the off state, and thus a bootstrap circuit cannot be used as the power supply for driving the gate of the first switching element 4a. However, in the case where the second switching element 4b is used for the on-off control, the first switching element 4a may be constantly in the off state, and thus either the separate power supply circuit or the bootstrap circuit may be used for the driving of the gate of the first switching element 4a.

As described above, with the DC power supply device 103 according to the third embodiment, the degree of freedom in the design of the power supply circuit configuration for driving the gate of the first switching element 4a can be increased and the cost of the circuit can be reduced further by the use of a bootstrap circuit or the like.

Except for the above-described features, the third embodiment is the same as the first or second embodiment.

### Fourth Embodiment

FIG. 1 to FIG. 3 are also referred to in the description of a DC power supply device 104 according to a fourth embodiment. The DC power supply device 104 according to the fourth embodiment has a circuit configuration in which conduction loss in the first switching element 4a is lower than conduction loss in the first backflow prevention element 5a.

In the full-wave rectification mode using the state A and the state B shown in FIG. 6(b), in the period of the state A, the first backflow prevention element 5a and the second backflow prevention element 5b exist in the current path passing through the first capacitor 6a and the second capacitor 6b as shown in FIG. 2. Therefore, the conduction loss occurs in both of the first backflow prevention element 5a and the second backflow prevention element 5b.

Further, in the full-wave rectification mode using the state A and the state B shown in FIG. 6(b), in the period of the state B, the first switching element 4a that has shifted to the on state, the second capacitor 6b, and the second backflow prevention element 5b exist in the current path as shown in FIG. 2, and the conduction loss occurs in the first switching element 4a and the second backflow prevention element 5b.

Therefore, in the DC power supply device 104 according to the fourth embodiment, a circuit configuration in which the conduction loss in the first switching element 4a is lower than the conduction loss in the first backflow prevention element 5a is employed and the ratio of the state B periods in the full-wave rectification mode using the state A and the state B shown in FIG. 6(b) is increased by setting the on duty ratio Dₐ of the first switching element 4a at or close to 100%. Accordingly, the conduction loss in the circuit can be reduced and the efficiency can be increased compared to the full-wave rectification mode (comparative example) using only the state A shown in FIG. 3. The on duty ratio D a is not limited to 100% but may be set based on the balance between the switching loss and the conduction loss so as to achieve operation with excellent efficiency.

Alternatively, in the DC power supply device 104 according to the fourth embodiment, a circuit configuration in which the conduction loss in the second switching element 4b is lower than the conduction loss in the second backflow prevention element 5b is employed and the ratio of the state C periods in the full-wave rectification mode using the state A and the state C shown in FIG. 10 is increased by setting the on duty ratio D_{b} of the first switching element 4b at or close to 100%. Accordingly, the conduction loss in the circuit can be reduced and the efficiency can be increased compared to the full-wave rectification mode (comparative example) using only the state A shown in FIG. 3. The on duty ratio D_{b} is not limited to 100% but may be set based on the balance between the switching loss and the conduction loss so as to achieve operation with excellent efficiency.

As described above, with the DC power supply device 104 according to the fourth embodiment, increased efficiency can be realized in the full-wave rectification mode in which the state B periods are extended in FIG. 6(b) or the full-wave rectification mode in which the state C periods are extended in FIG. 10.

Except for the above-described features, the fourth embodiment is the same as any one of the first to third embodiments.

### Fifth Embodiment

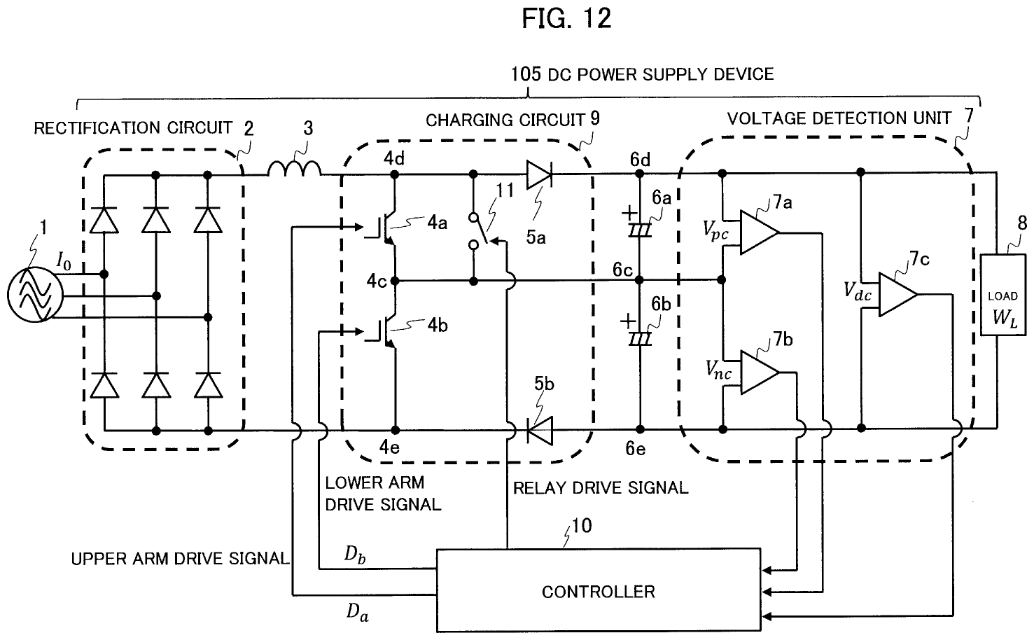

FIG. 12 is a diagram showing a configuration example of a DC power supply device 105 according to a fifth embodiment. As shown in FIG. 12, the DC power supply device 105 according to the fifth embodiment differs from the DC power supply device 101 shown in FIG. 1 in including a relay circuit 11 as a low-loss switching circuit connected in parallel with the first switching element 4a. The relay circuit 11 is on-off controlled by the controller 10. In this case, the relay circuit 11 is referred to also as a first relay circuit.

In the DC power supply device 105 according to the fifth embodiment, the full-wave rectification mode as the combination of the state A and the state B shown in FIG. 6(b) is executed, and at the stage when the stationary state has started after the convergence of the charging/discharging of the first capacitor 6a and the second capacitor 6b, the relay circuit 11 is set in the on state and the collector and the emitter of the first switching element 4a are brought into a short circuit state. Accordingly, the charging current for the second capacitor 6b starts flowing through the relay circuit 11 having lower resistance than the first switching element 4a and circuit loss can be reduced. Furthermore, in the case where the relay circuit 11 is set in the on state, it is unnecessary to drive the first switching element 4a at the 100% on duty ratio.

It is also possible to connect the relay circuit 11 in parallel with the second switching element 4b. In this case, the relay circuit 11 is referred to also as a second relay circuit. In that case, the full-wave rectification mode as the combination of the state A and the state C shown in FIG. 10 is executed, and at the stage when the stationary state has started after the convergence of the charging/discharging of the first capacitor 6a and the second capacitor 6b, the collector and the emitter of the second switching element 4b are brought into the short circuit state by setting the relay circuit 11 in the on state. Accordingly, the charging current for the first capacitor 6a starts flowing through the relay circuit 11 having lower resistance than the second switching element 4b and the circuit loss can be reduced. Furthermore, in the case where the relay circuit 11 is set in the on state, it is unnecessary to drive the second switching element 4b at the 100% on duty ratio.

Furthermore, the timing for setting the relay circuit 11 in the on state does not necessarily have to be the stage when the stationary state has started after the convergence of the charging/discharging of the first capacitor 6a and the second capacitor 6b; the timing can be at any time when the peak of the charging current for the first capacitor 6a or the second capacitor 6b occurring when the relay circuit 11 is turned on is permissible. Further, it is also possible to connect two relay circuits respectively in parallel with the first switching element 4a and the second switching element 4b. The purpose of using the relay circuit 11 is to prepare a low-loss current path instead of the first switching element 4a or the second switching element 4b, and thus the relay circuit 11 may be arranged depending on the energization pattern in the full-wave rectification mode shown in FIG. 6(b) or FIG. 10.

As described above, with the DC power supply device 105 according to the fifth embodiment, increased efficiency in the full-wave rectification mode can be realized in the full-wave rectification mode shown in FIG. 6(b) or FIG. 10.

Except for the above-described features, the fifth embodiment is the same as any one of the first to fourth embodiments.

### Sixth Embodiment

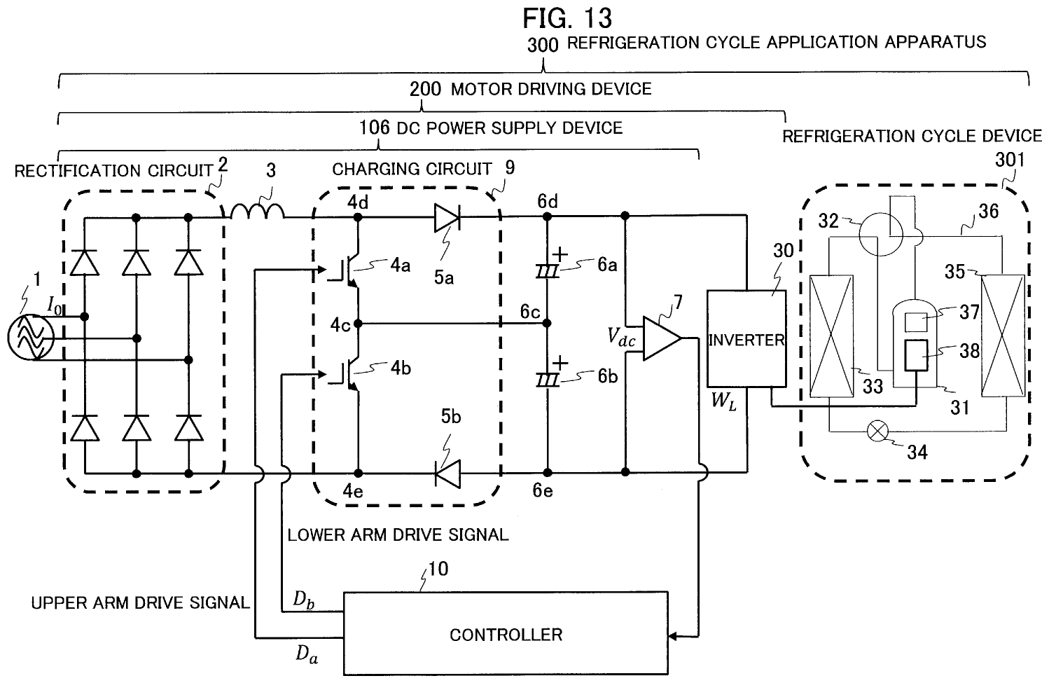

A six embodiment relates to a DC power supply device, a motor driving device including the DC power supply device and an inverter, and a refrigeration cycle application apparatus including the motor driving device and a refrigeration cycle device. FIG. 13 is a diagram showing a configuration example of a DC power supply device 106, a motor driving device 200 and a refrigeration cycle application apparatus 300 according to the sixth embodiment. As the DC power supply device 106, any one of the DC power supply devices 101 to 105 according to the first to fifth embodiments can be used.

In the example shown in FIG. 13, the load circuit of the DC power supply device 106 is an inverter 30. The inverter 30 converts the direct current supplied from the DC power supply device 106 to an alternating current. In FIG. 13, the motor driving device 200 includes the DC power supply device 106 and the inverter 30. In FIG. 13, the refrigeration cycle application apparatus 300 includes the motor driving device 200 and a refrigeration cycle device 301. The refrigeration cycle device 301 includes a compressor 31, a four-way valve 32, an internal heat exchanger 33, an expansion mechanism 34, a heat exchanger 35, and refrigerant piping 36 connecting these components. The compressor 31 includes a compression mechanism 37 for compressing a refrigerant and a motor (i.e., compressor motor) 38 for driving the compression mechanism 37. The motor 38 receives electric power for driving from the inverter 30 connected to the DC power supply device 106.

Next, the operation in a case where the refrigeration cycle device 301 is an air conditioner will be described below. When the power consumption by the inverter 30 is high (i.e., when the load W L is high), it is desirable to increase the output voltage V_{dc} [V] to the inverter 30 by using one of the step-up modes a1, a2 and a3 shown in FIG. 3. When the power consumption by the inverter 30 is low (i.e., when the load W_{L} is low), it is desirable to operate the air conditioner with a high power factor and high efficiency by using the full-wave rectification mode described in the first to fifth embodiments.

In the operation of the refrigeration cycle device 301, the DC power supply device 106 according to the sixth embodiment may switch the operation mode to the full-wave rectification mode with the energization pattern including the state A and the state B shown in FIG. 6(b) (referred to also as a first full-wave rectification mode) or the full-wave rectification mode with the energization pattern including the state A and the state C shown in FIG. 10 (referred to also as a second full-wave rectification mode). For example, the second capacitor 6b is charged/discharged in the full-wave rectification mode with the energization pattern shown in FIG. 6(b) at the first startup of the motor 38, and the first capacitor 6a is charged/discharged in the full-wave rectification mode with the energization pattern shown in FIG. 10 at the second startup of the motor 38.

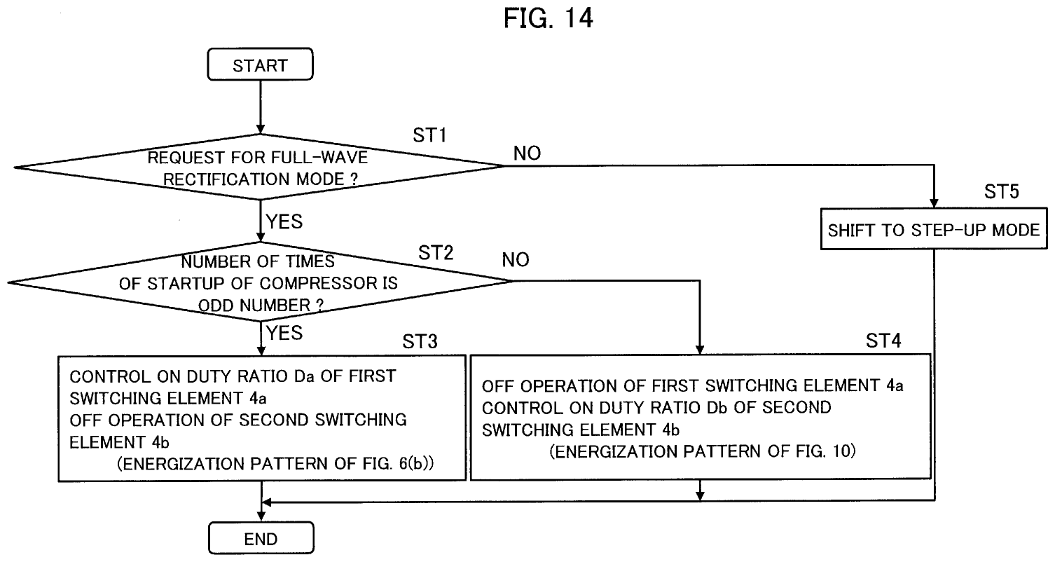

FIG. 14 is a flowchart showing an operation example of the switching of the energization pattern of the DC power supply device 106 according to the sixth embodiment. As shown in FIG. 14, the controller 10 judges whether or not there is a request for the full-wave rectification mode (step ST1), and if there is a request (YES in the step ST1), judges whether or not the number of times of startup of the motor 38 is an odd number (step ST2). Here, when the number of times of startup is judged to be an odd number (YES in the step ST2), the controller 10 at the startup makes the charging circuit 9 operate in the energization pattern shown in FIG. 6(b), charge/discharge the first capacitor 6a, and charge the second capacitor 6b (step ST3). When the number of times of startup is judged to be an even number (NO in the step ST2), the controller 10 at the startup makes the charging circuit 9 operate in the energization pattern shown in FIG. 10, charge/discharge the second capacitor 6b, and charge the first capacitor 6a (step ST4).

By this operation, charging/discharging times of the first capacitor 6a and the second capacitor 6b can be leveled out, and the operating life of the capacitors can be extended compared to cases where only one capacitor is used as the charging/discharging capacitor in the full-wave rectification mode. Furthermore, when there is no request for the full-wave rectification mode in the step ST1 (NO in step ST1), the controller 10 shifts the operation mode to a step-up mode shown in FIG. 3 (step ST5).

Furthermore, the controller 10 may use an operation time of the DC power supply device 106, an operation time of the compressor 31 or the charging/discharging time of each capacitor as a trigger for switching the capacitor for the charging/discharging. The purpose of the sixth embodiment is to extend the operating life of the capacitors compared to cases where only one of the first capacitor 6a and the second capacitor 6b is continuously used as the capacitor for the charging/discharging in the full-wave rectification mode. Therefore, by use of the aforementioned trigger, which one of the first capacitor 6a and the second capacitor 6b should be used as the capacitor for the charging/discharging may be switched alternately and the charging/discharging time of each capacitor may be adjusted so that the charging/discharging times of the two capacitors become equal to each other.

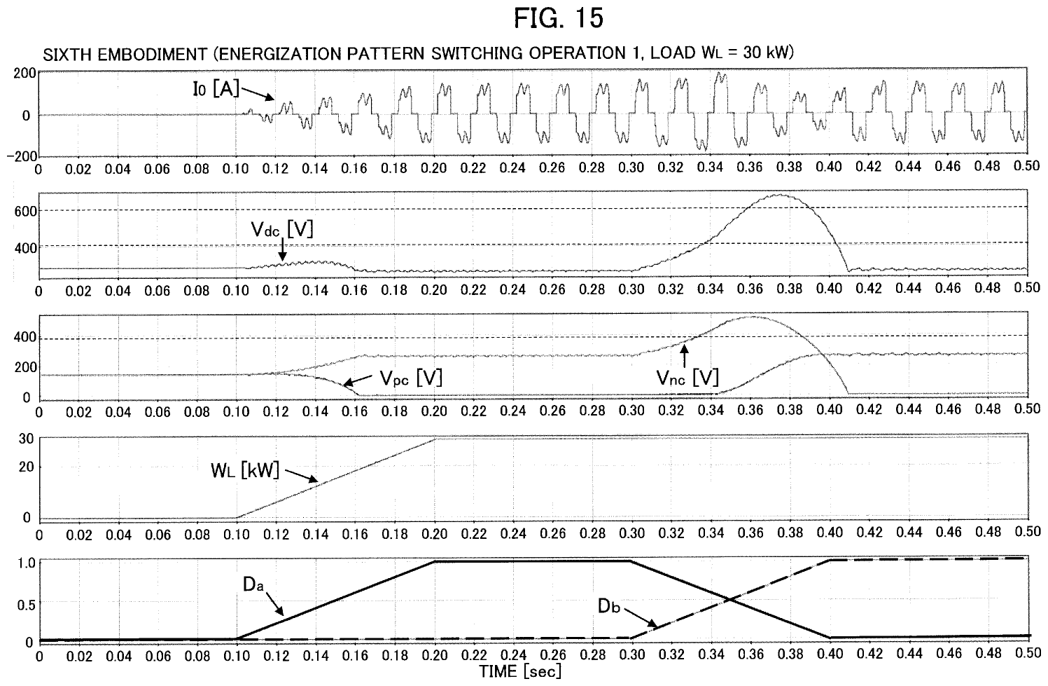

Further, a description will be given below of a method of switching the energization pattern to the energization pattern of FIG. 6(b) or the energization pattern of FIG. 10 in a state in which the compressor 31 is in operation. FIG. 15 shows an example of waveforms of the input current I₀ [A] to the rectification circuit 2, the output voltage V_{dc} [V] detected by the third detection unit 7c, the voltages V_{pc} [V] and V_{dc} [V] detected by the first and second detection units 7a and 7b, the load W_{L} [kW], and the on duty ratio Dₐ of the first switching element 4a at the time of switching the energization pattern of the DC power supply device 106 according to the sixth embodiment. FIG. 15 shows an example of operation waveforms when the switching is made from the energization pattern of FIG. 6(b) to the energization pattern of FIG. 10.

In FIG. 15, the energization pattern of FIG. 6(b) is started at the time point of 0.1 seconds and the on duty ratio Dₐ of the first switching element 4a increases gradually (e.g., linearly) from 0% to 100%. Thereafter, from a time point of 0.3 seconds, the on duty ratio Dₐ of the first switching element 4a decreases gradually (e.g., linearly) from 100% to 0%. Further, from the time point of 0.3 seconds, the on duty ratio D_{b} of the second switching element 4b increases gradually from 0% and increases linearly to 100%. Accordingly, to the time point of 0.3 seconds, the second capacitor 6b operates as the capacitor for the charging/discharging and its voltage value is a voltage value obtained by the full-wave rectification by the rectification circuit 2.

However, in a period from the switching of the energization pattern to the start of the stationary state with the energization pattern of FIG. 10, namely, after a time point of approximately 0.4 seconds, the first capacitor 6a operates as the capacitor for the charging/discharging and its voltage value is a voltage value obtained by the full-wave rectification by the rectification circuit 2. Further, in a period from the time point of 0.3 seconds to a time point of 0.4 seconds, the device is in a state of making both of the first switching element 4a and the second switching element 4b execute the switching operation and reaches an operational state as one of the step-up modes a1, a2 and a3 shown in FIG. 3, and thus the device temporarily executes the step-up operation in this period. Accordingly, the output voltage V_{dc} [V] of the DC power supply device at the time of switching the energization pattern becomes higher than the output voltage V_{dc} [V] before switching the energization pattern, and thus the energization pattern can be switched while driving the load circuit 8 without running short of electric power when driving the load circuit 8.

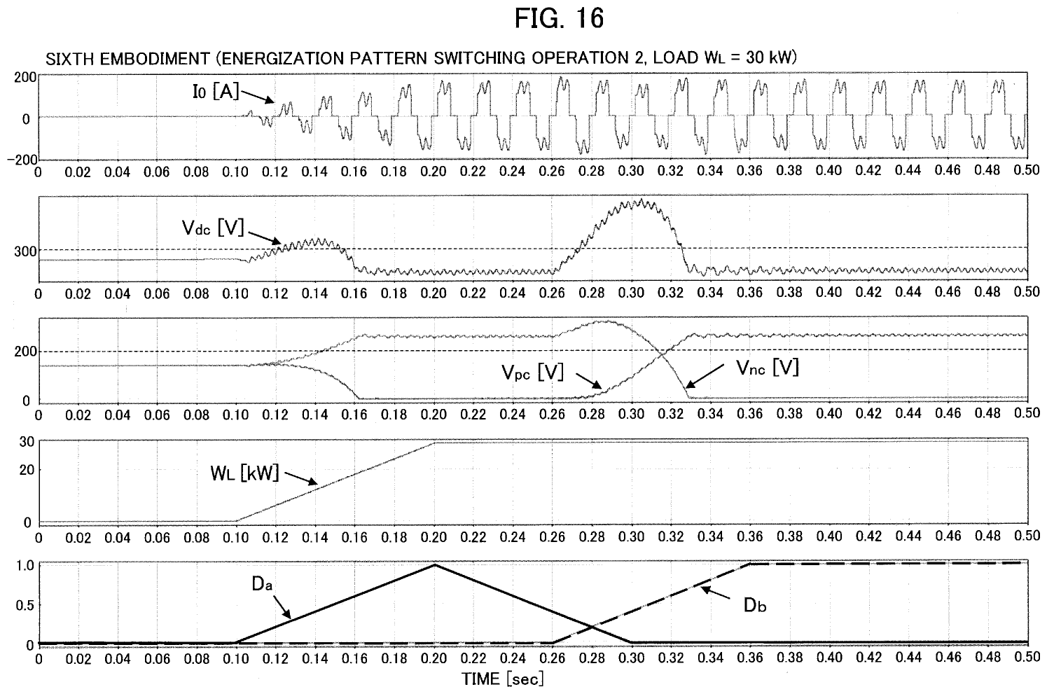

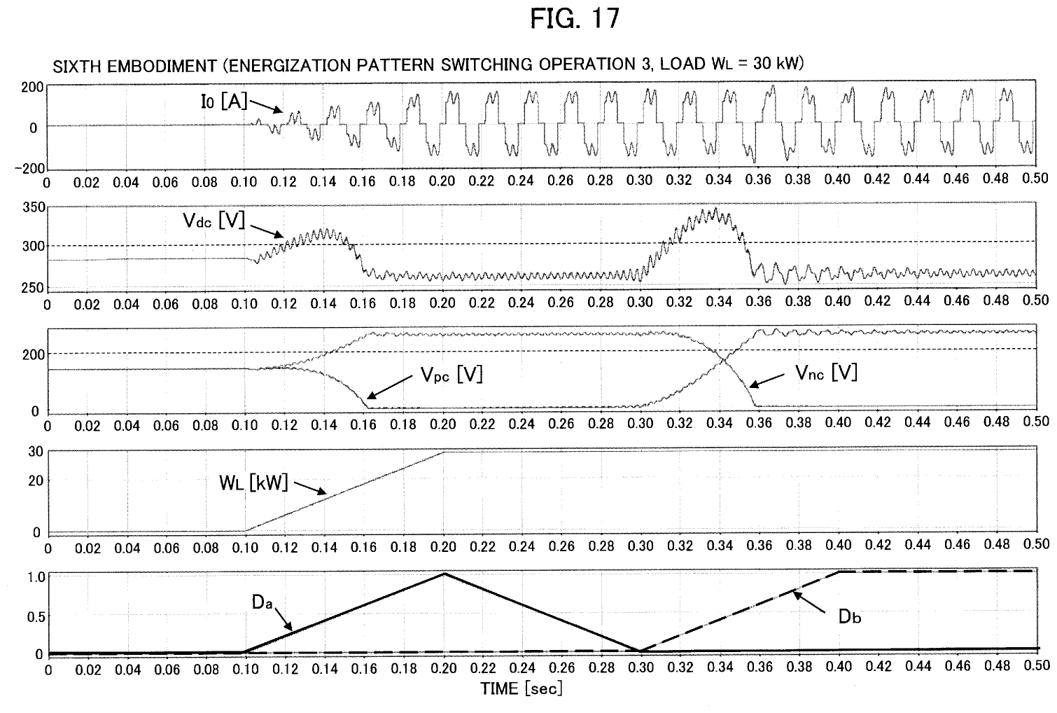

FIG. 16 and FIG. 17 show other examples of the waveforms of the input current I₀ to the rectification circuit 2, the output voltage V_{dc} [V] detected by the third detection unit 7c, the voltages V_{pc} [V] and V_{dc} [V] detected by the first and second detection units 7a and 7b, the load W_{L} [kW], and the on duty ratio Dₐ of the first switching element 4a at the time of switching the energization pattern of the DC power supply device 106 according to the sixth embodiment. When it is desired to hold down the voltage rise due to the step-up operation, the purpose can be achieved by previously reducing the on duty ratio Dₐ of the first switching element 4a (e.g., from the time point of 0.20 seconds) and then increasing the on duty ratio D_{b} of the second switching element 4b as shown in FIG. 16 or FIG. 17. Furthermore, also when the switching is made from the energization pattern of FIG. 10 to the energization pattern of FIG. 6(b), the purpose can be achieved similarly by reducing the on duty ratio D_{b} of the second switching element 4b and then increasing the on duty ratio Dₐ of the first switching element 4a. Further, while the on duty ratio is changed linearly in the sixth embodiment, the on duty ratio may also be changed stepwise or like an S-shaped curve depending on the charging current peak of the capacitor or the voltage level at the time of stepping up the voltage.

As described above, the controller 10 of the DC power supply device 106 according to the sixth embodiment is capable of executing the control of alternately switching between the first full-wave rectification mode in which the second switching element 4b is maintained in the off state and the on duty ratio of the first switching element 4a when the voltage of the direct current has reached the stationary state is set at a value greater than 0% and less than or equal to 100% and the second full-wave rectification mode in which the first switching element 4a is maintained in the off state and the on duty ratio of the second switching element 4b when the voltage of the direct current has reached the stationary state is set at a value greater than 0% and less than or equal to 100%. Therefore, cumulative charging/discharging times of the first and second capacitors 6a and 6b can be leveled out and it is possible to contribute to extending the operating life of the DC power supply device 106.

Further, the controller 10 of the DC power supply device 106 according to the sixth embodiment is capable of executing the control of making the period of gradually decreasing the on duty ratio of the first switching element 4a and the period of gradually increasing the on duty ratio of the second switching element 4b overlap or partially overlap with each other in the transient state of the switching from the first full-wave rectification mode to the second full-wave rectification mode and making the period of gradually decreasing the on duty ratio of the second switching element 4b and the period of gradually increasing the on duty ratio of the first switching element 4a overlap or partially overlap with each other in the transient state of the switching from the second full-wave rectification mode to the first full-wave rectification mode. Therefore, continuous operation without stopping the refrigeration cycle device 301 becomes possible.

Furthermore, the controller 10 of the DC power supply device 106 according to the sixth embodiment is capable of making the transient state include a period in which both of the first switching element 4a and the second switching element 4b are individually driven in a range where the on duty ratio is greater than 0% and less than or equal to 100% and making the output voltage V_{dc} be higher than the voltage outputted from the rectification circuit 2. Therefore, an electric power shortage at the time of the switching can be avoided.

Moreover, with the refrigeration cycle application apparatus 300 according to the sixth embodiment, the energization pattern can be switched while continuously driving the motor 38, and continuous operation without stopping the refrigeration cycle device 301 becomes possible.

1. A DC power supply device comprising:
a rectification circuit to rectify an alternating current;
a reactor connected to the rectification circuit;
a first capacitor and a second capacitor connected in series between output terminals for a direct current generated by the rectification circuit and the reactor;
a first switching element to set the first capacitor in a charging state when the first switching element is in an off state and to set the first capacitor in a non-charging state when the first switching element is in an on state;
a second switching element to set the second capacitor in the charging state when the second switching element is in the off state and to set the second capacitor in the non-charging state when the second switching element is in the on state; and
a controller to control switching operation of each of the first and second switching elements,
wherein the controller has a full-wave rectification mode as an operation mode in which one of the first and second switching elements is maintained in the off state and an other one of the first and second switching elements undergoes PWM control,
wherein, when voltage of the direct current is in a stationary state, the controller executes control of alternately switching between:
a first full-wave rectification mode in which the second switching element is maintained in the off state and an on duty ratio of the first switching element is set at a value greater than 0% and less than or equal to 100%; and
a second full-wave rectification mode in which the first switching element is maintained in the off state and the on duty ratio of the second switching element when the voltage of the direct current has reached the stationary state is set at a value greater than 0% and less than or equal to 100%.

2. (canceled)

3. (canceled)

4. The DC power supply device according to claim 1, further comprising a first backflow prevention element to prevent a back flow of electric charge for charging the first capacitor,
wherein conduction loss in the first switching element is lower than conduction loss in the first backflow prevention element.

5. The DC power supply device according to claim 1, further comprising a first relay circuit connected in parallel with the first switching element,
wherein the controller executes control of setting the first relay circuit in the on state instead of driving the first switching element at the 100% on duty ratio.

6. (canceled)

7. The DC power supply device according to claim 1, further comprising a second backflow prevention element to prevent a back flow of electric charge for charging the second capacitor,
wherein conduction loss in the second switching element is lower than conduction loss in the second backflow prevention element.

8. The DC power supply device according to claim 1, further comprising a second relay circuit connected in parallel with the second switching element,
wherein the controller executes control of setting the second relay circuit in the on state instead of driving the second switching element at the 100% on duty ratio.

9. The DC power supply device according to claim 1, wherein the controller executes control of alternately switching between
the first full-wave rectification mode and
the second full-wave rectification mode.

10. The DC power supply device according to claim 9, wherein the controller executes control of:
making a period of gradually decreasing the on duty ratio of the first switching element and a period of gradually increasing the on duty ratio of the second switching element overlap or partially overlap with each other in a transient state of the switching from the first full-wave rectification mode to the second full-wave rectification mode; and
making a period of gradually decreasing the on duty ratio of the second switching element and a period of gradually increasing the on duty ratio of the first switching element overlap or partially overlap with each other in a transient state of the switching from the second full-wave rectification mode to the first full-wave rectification mode.

11. The DC power supply device according to claim 10, wherein the controller makes the transient state include a period in which both of the first switching element and the second switching element are individually driven in a range where the on duty ratio is greater than 0% and less than or equal to 100% and makes output voltage be higher than voltage outputted from the rectification circuit.

12. A motor driving device comprising:
the DC power supply device according to claim 1; and
an inverter to convert the direct current to an alternating current and to supply the alternating current to a motor.

13. A refrigeration cycle application apparatus comprising:
the motor driving device according to claim 12; and
a refrigeration cycle device including a motor driven by the motor driving device.
